(19) United States
(12) Patent Application Publication
(10) Pub. No.: US 2026/0175532 A1
(43) Pub. Date: Jun. 25, 2026

(54) SEAMLESS AND JOINTLESS GLASS FIBRE REINFORCED COMPOSITE LINING FOLDED INTO PIPE SHAPE WITH ENVELOPE FOLDING TECHNIQUE FOR TRENCHLESS REPAIR OF PIPELINES

(71) Applicant: TELATEKS TEKSTIL ÜRÜNLERI SANAYI VE TICARET ANONIM SIRKETI, ISTANBUL (TR)

(72) Inventor: Gülnur BASER, ISTANBUL (TR)

(21) Appl. No.: 18/836,897

(22) PCT Filed: Oct. 18, 2023
(86) PCT No.: PCT/TR2023/051160

§ 371 Date: Aug. 8, 2024

(30) Foreign Application Priority Data
May 30, 2023 (TR) 2023/006191

(51) Int. Cl. B32B 1/08; B32B 3/04; B32B 5/26

(52) U.S. Cl. CPC B32B 1/08; B32B 3/04; B32B 5/262; B32B 2250/03; B32B 2250/20; B32B 2260/023; B32B 2260/046; B32B 2262/101; B32B 2262/16; B32B 2307/71; B32B 2597/00

(57) ABSTRACT

Disclosed is a glass fibre reinforced composite liner for the trenchless repair of underground pipelines such as drinking water and wastewater pipelines. The primary and secondary glass fibre fabric layers are interwoven and folded into a pipe shape by an envelope folding technique for a seamless and jointless roll without the need for seams, and a continuous curable tubular surface is provided by the homogeneous wetting of the two layers with the resin.

### TECHNICAL FIELD

The invention relates to a glass fibre reinforced composite liner, especially designed for use in the trenchless repair method of underground pipelines, such as drinking water and waste water pipelines, which is folded into a pipe (tubular) shape by envelope folding technique, seamless and without seams.

### KNOWN STATE OF THE ART

Drinking water and wastewater systems in metropolises and metropolitan cities age over time and need to be rehabilitated. Different techniques are used in the rehabilitation of drinking water and wastewater systems. Traditional techniques such as open excavation bring many problems and difficulties that negatively affect urban life during the application. There are disadvantages such as the continuity of transmission in the line during the application, collapses that may occur in the excavation area, and damage to other services such as telephone and electricity. Interruption of daily activities (water, electricity, traffic and business life etc.) is another problem. The cost of removing, transporting and processing the excavated products may exceed the cost of laying new lines.

In order to minimise these negative impacts, “Trenchless Technologies”, in which advanced technology and innovative materials are used intensively, have emerged and have started to be used in developed countries, especially in the rehabilitation of drinking water and waste water lines. In this context, the “lining technique inside the pipe”, which allows on-site pipe repair in a short time without excavation, has become widespread in the world. For example, in the patent U.S. Pat. No. 6,679,966B1, the lining pipe consists of resin impregnated fibre between the inner foil layer and the outer foil layer. The production of the lining tube is described in patent U.S. Pat. No. 5,798,013 by winding the resin-impregnated fibre in a spiral on the mandrel with inner foil and then coating the outer foil.

This trenchless repair technique is also applied in our country and the composite lining material used as the main material is imported from abroad. Imported material increases the application cost. In addition, the joints on the imported products create pot holes on the pipe surface or cause collapses during application. As a result of these problems, the lining formation process inside the pipe fails and even the material has to be removed from the pipe and cleaned. This can lead to laborious and costly process requirements such as digging and breaking open.

In the present state, the fabric is brought into tube form and impregnated with resin. After the tubular fabric is placed in the pipe, it is shaped into the wall with compressed air and cured with light. When the linings used in the current technique are in spiral form, collapses occur on the fabric. Complete curing cannot be achieved. The cured fabric is expected to be uniform and homogenous on the walls. In spiral form, these collapses prevent this. When the linings used in the present technique have a stitched joint, discontinuity occurs at the seam. Discontinuity also poses a problem in terms of sealing. The seams create a pot hole in the wall and disrupt the order in the pipe wall. This irregularity on the surface adversely affects the hydraulic behaviour.

For the lining formation technique in the pipe, which enables trenchless repair of drinking water and wastewater systems, it is necessary to develop a tubular liner fabric without seams and joints, using a folding technique different from existing solutions.

As a result, due to the above-mentioned disadvantages and the inadequacy of the existing solutions, a development in the relevant technical field has become necessary.

### OBJECT OF THE INVENTION

The invention is inspired by the present invention and aims to solve the above-mentioned problems.

The main object of the invention is to provide a seamless and jointless tubular lining fabric with a new folding technique used for the lining formation technique in a reinforced concrete or different structured pipe, which enables trenchless repair of drinking water and waste water systems.

An object of the invention is to provide a lining fabric which, by means of a folding technique, forms a full circular surface on a tubular film and, by means of the impregnated resin, forms a seamless continuous surface on the walls of the tube.

In order to fulfil the above-mentioned objects, the invention is a seamless and jointless flexible composite liner designed for use in the trenchless repair of underground pipelines, such as drinking water and waste water pipelines, and comprising; in its basic form, a primary glass fibre fabric layer folded in a U-shape with two open ends meeting in one direction, and a secondary glass fibre fabric layer folded in a U-shape over said primary glass fibre fabric with two open ends meeting in the other direction.

The structural and characteristic features and all advantages of the invention will be more clearly understood by means of the figures given below and the detailed description written by making references to these figures, and therefore, the evaluation should be made by taking these figures and detailed description into consideration.

### FIGURES TO HELP UNDERSTANDING THE INVENTION

FIG. 1 is a (a) before folding, (b) after folding, (c) cross-sectional views in application and (d) perspective views in application of the fabric layers comprising the composite liner subject to the invention.

FIG. 2 is a (a) cross-sectional and (b) perspective views, in application of the fabric layers comprised in a preferred embodiment of the composite liner subject to the invention.

### DESCRIPTION OF PART REFERENCES

100 composite lining
10 inner film layers
20 primary glass fibre fabric layer
21 open ends
22 nonwovens textiles (felt) layer
30 secondary glass fibre fabric layer
31 open ends
40 outer film layers
50 UV-protected film layer

### DETAILED DESCRIPTION OF THE INVENTION

In this detailed description, the preferred embodiments of the composite liner which are the subject matter of the invention are described only for a better understanding of the subject matter.

The invention relates to a composite liner (100) designed for use in the trenchless repair of underground pipelines, such as drinking water and wastewater pipelines.

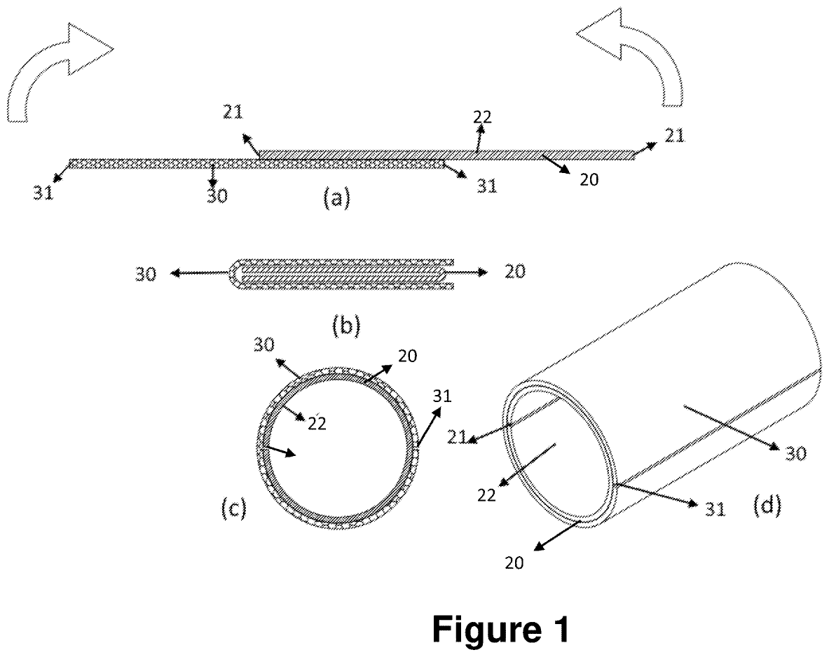

As shown in FIGS. 1a and 1b, the inventive flexible composite liner (100), in its most basic form, comprises a primary glass fibre fabric layer (20) folded in a U-shape so that its two open ends (21) meet in one direction and a secondary glass fibre fabric layer (30) folded in a U-shape over said primary glass fibre fabric (20) so that the two open ends (31) meet in the other direction. The said glass fibre fabric layers (20,30) may comprise layers of non-crimped glass fibre fabric and/or woven glass fibre fabric.

According to an embodiment of the invention, the primary glass fibre fabric layer (20) comprises at least one nonwoven textiles (felt) layer (22) bonded to its inner surface. The nonwoven textiles (felt) layer (22) may comprise individuals or combinations selected from the group consisting of polyester, viscose, polyamide, glass-based nonwoven textiles (felt).

According to an embodiment of the invention, the folded primary glass fibre fabric layer (20) and the secondary glass fibre fabric layers (20,30) are impregnated with UV curable resin.

According to an embodiment of the invention, the said primary glass fibre fabric layer (20) comprises a UV transparent tubular inner film layer (10) positioned to be contained within said primary glass fibre fabric layer (20).

According to an embodiment of the invention, the said secondary glass fibre fabric layer (30) comprises a protective outer film layer (40).

In one embodiment of the invention, the said outer film layer (40) comprises a UV-protected film layer (50).

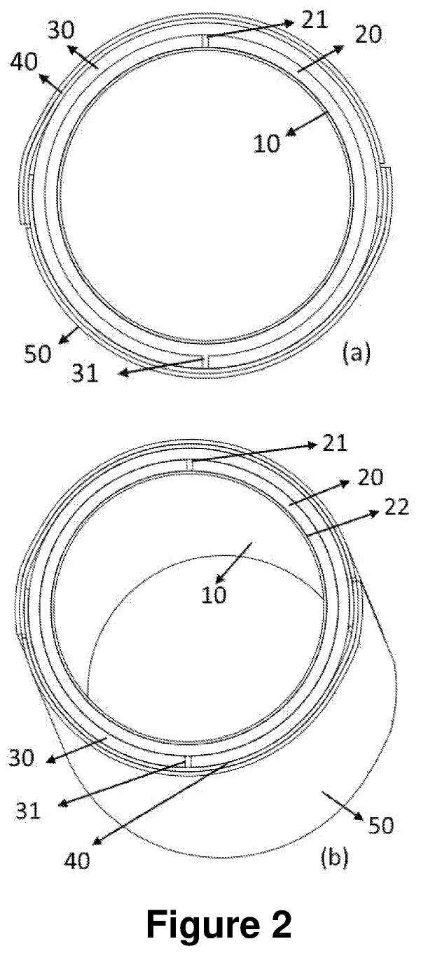

FIGS. 2a and 2b show a cross-sectional and perspective view of a preferred embodiment of the invention as a result of compressed air application in a pipe. The composite liner comprises, from the inside outwards, respectively: a UV permeable tubular inner film layer (10); a primary glass fibre fabric layer (20) combined with a nonwoven textiles (felt) layer (22); a secondary glass fibre fabric layer (30); a protective outer film layer (40) and a UV protected film layer (50). In the preferred embodiment, polyester nonwovens are used as the nonwoven textiles (felt) and non-crimped glass fibre is used as the glass fibre.

Within the scope of the invention, half of the primary glass fibre fabric layer (20) is laid on the secondary glass fibre layer (30) with the envelope folding technique (FIG. 1a). The other half of the secondary glass fibre fabric layer (20) is folded over itself in a U-shape (FIG. 1b). The two open ends (21) of this fabric layer coincide at the midpoint of the other fabric layer, facing each other. The outer half of the secondary glass fibre layer (30) is also folded in a U-shape over the primary glass fibre fabric layer (20), which is folded in half. The two exposed ends of this fabric layer (31) continue to cover the primary glass fibre fabric layer (20) from above and below and end by facing each other. The nonwoven textiles (felt) layer (22), which is bonded to the inner surface of the primary glass fibre fabric layer (20), provides smoothness as the inward facing part of the tube. As can be seen in FIG. 1c, the fabric layers (20,30) folded as described form a closed circular cross-section when inflated with compressed air. In practice, the composite liner (100) formed in this way can cover the walls of the repaired pipe continuously and without collapse, as shown in FIG. 1d.

In the preferred embodiment of the invention, a composite liner comprising a primary glass fibre layer (20) that combined with a nonwoven textiles (felt) layer (22) and a secondary glass fibre layer (30), which is folded on top of each other as described, is impregnated with a UV curable resin. As can be seen in FIG. 2a-b, in the application, a UV-permeable tubular inner film layer (10) is included in the fabric layers (20,30) forming a flexible layer so that the composite liner can be inflated with air and maintain its tubular shape. The polyester nonwoven textiles (felt), one of the structural components for folding and trenchless repair, faces the inside of the tube and ensures smoothness. In order to protect the composite liner (100), the secondary glass fibre layer (30) is covered with a protective plastic outer film layer (40). Since the flexible structure consisting of fabric layers (20,30) is impregnated with UV curable resin, it must not transmit sunlight. For this reason, the outer film layer (40) is covered with a UV-protected film layer (50).

For the lining of a damaged reinforced concrete pipe to be rehabilitated, a layered composite liner (100) is placed in the pipe, inflated with compressed air and UV light is applied. The UV light passes through the inner film layer (10), which has taken the shape of the pipe, and reaches the primary glass fibre fabric layer (20) and the secondary glass fibre fabric layer (30), allowing the impregnated UV curable resin to harden and the composite liner (100) to take the shape of the pipe.

1. A seamless and jointless flexible composite liner for use in the trenchless repair of underground pipelines such as drinking water and wastewater pipelines, folded in the form of a pipe by an envelope folding technique, the composite liner comprising:
a primary glass fibre fabric layer, which is folded in a U-shape so that its two open ends meet in one direction,
a secondary glass fibre fabric layer folded in a U-shape on said primary glass fibre fabric so that the two open ends meet in the other direction.

2. The composite liner according to claim 1, further comprising; at least one nonwoven textiles (felt) layer bonded to the inner surface of the primary glass fibre fabric layer.

3. The composite liner according to claim 2, wherein the nonwoven textiles (felt) layer is an individual or a combination of material selected from the group consisting of polyester, viscose, polyamide, and glass-based nonwoven textiles (felt).

4. The composite liner according to claim 1, wherein the glass fibre fabric layers are non-crimped and/or woven glass fibre fabric.

5. The composite liner according to claim 1, further comprising; a UV-permeable tubular inner film layer positioned within the primary glass fibre fabric layer

6. The composite liner according to claim 1, further comprising; a UV curable resin that is impregnated in the layers of the folded glass fibre fabric.

7. The composite liner according to claim 1, further comprising; a protective outer film layer on the secondary glass fibre fabric layer.

8. The composite liner according to claim 7, further comprising; a UV protective film layer on the outer film layer.
